(19) United States
(12) Patent Application Publication
(10) Pub. No.: US 2012/0160119 A1
(43) Pub. Date: Jun. 28, 2012

(54) PRODUCTION OF TRANSFER PAPER FOR INK-JET PRINTING

(75) Inventor: Zvonimir Martinovic, Varazdin (HR)

(73) Assignee: AZOURITE VENTURES LTD., Limassol, CY (CY)

(21) Appl. No.: 13/262,290

(22) PCT Filed: Mar. 30, 2010
(86) PCT No.: PCT/EP2010/054204

§ 371 Date: Mar. 15, 2012

(30) Foreign Application Priority Data
Mar. 30, 2009 (EP) 09004614.5

(51) Int. Cl. B41M 3/12

(52) U.S. Cl. 101/488; 427/152

(57) ABSTRACT

The present invention relates to a method for producing transfer papers, to the transfer papers produced by the method, and to transfer printing methods.

The present invention relates to a method for producing transfer papers, to the transfer papers produced by the method, and to transfer printing methods.

Transfer printing denotes the printing of different materials, such as textiles, using transfer papers. Transfer papers are coated with pigments which are subsequently transferred onto the printable materials by sublimation using a thermal transfer press.

WO 00/06392 discloses a transfer paper, in particular for ink-jet printing, provided, at least on the side to be printed, with a release or barrier layer, the layer having a porosity of at most 100 ml/min.

A drawback frequently encountered in known transfer papers is that the pigments, applied for example by ink-jet printing, smear. This problem arises even when using transfer papers which have been coated with hydrophilic polymers, such as carboxymethyl cellulose, before applying the pigment layer.

Surprisingly, it has been found that if the transfer papers are coated with aqueous liquids which comprise ammonium polyacrylate, the drawbacks described above can be at least largely eliminated.

Thus, a first aspect of the invention relates to a method for producing transfer paper, in particular for ink-jet printing, comprising the steps of:

(a) applying a first aqueous liquid to the front side, which is to be printed, of a paper, the first aqueous liquid comprising ammonium polyacrylate, and subsequent drying, and

(b) optionally applying a second aqueous liquid to the reverse side of the paper and subsequent drying, the second liquid optionally comprising ammonium polyacrylate.

The starting material used for producing the transfer paper is a conventional paper, for example white or unbleached paper, having a weight of conventionally 60-140 g, in particular 80-120 g per m² paper.

According to step (a) of the method according to the invention, the front side which is to be printed, i.e. the side which is subsequently coated with pigments, is brought into contact with a first aqueous liquid which comprises ammonium polyacrylate. The ammonium polyacrylate used for the coating conventionally has a weight-average molecular weight of 500 Da or more, for example 1000-5000 Da and in particular 1000-2000 Da. The first aqueous liquid preferably comprises ammonium polyacrylate in a proportion of 10-50% by weight, in particular in a proportion of 20-40% by weight, based on the total weight of the liquid. The first aqueous liquid can be applied by conventional methods, for example using a doctor such as a doctor blade or a roll doctor, or by spraying. After the application, the paper is conventionally dried at an increased temperature, for example 40-80° C.

Step (b) preferably comprises applying a second aqueous liquid to the reverse side of the paper and subsequent drying. The second aqueous liquid preferably comprises a hydrophilic organic polymer, in particular ammonium polyacrylate. The second aqueous liquid comprises ammonium polyacrylate or another organic polymer, preferably in a proportion of 5 to 30% by weight, in particular in a proportion of 10 to 20% by weight, based on the total weight of the liquid. The application of the second liquid and the subsequent drying can be provided by known methods, as with the first liquid.

The first and optionally the second aqueous liquid are conventionally applied to the paper in an amount of 10-40 g, in particular of 15-25 g per m², it also being possible to apply larger or smaller amounts in some embodiments. It is further preferred for the ammonium polyacrylate to be applied to the front side of the paper in an amount of 1-25 g, in particular 2-20 g dry weight. The ammonium polyacrylate (or another hydrophilic polymer) is preferably applied to the reverse side in an amount of 0.5-15 g, in particular of 1-10 g dry weight.

The first aqueous liquid and optionally also the second aqueous liquid may have a neutral to alkaline pH, for example a pH of ≧7, for example 9.

The first aqueous liquid may optionally also comprise further additives as well as the ammonium polyacrylate, for example inorganic additives such as SiO₂ or silicates, organic additives, in particular organic polymers such as cellulose derivatives, for example carboxymethyl cellulose, and/or non-volatile low-molecular organic substances, in particular polyhydric alcohols such as glycerine. In particularly preferred embodiments, the additives are selected from:

(i) SiO₂ or silicates, for example in proportions of 10-50% by weight, in particular of 10-30% by weight

(ii) cellulose derivatives such as carboxymethyl cellulose, for example in proportions of 5-25% by weight, in particular of 5-15% by weight, and/or

(iii) polyhydric alcohols such as glycerine, for example in proportions of 5-25% by weight, in particular of 10-20% by weight,

the proportions by weight being based on the total weight of the first liquid in each case.

After the stated additives, the remainder of the liquid preferably consists of water. The proportion of water in the first liquid is preferably 50% by weight, in particular 70% by weight. There are preferably no organic volatile solvents.

In the following, preferred specific examples of aqueous liquids according to the invention for coating the front side of the paper are given as follows:

Coating liquid 1

| | |
|---|---|
| colloidal SiO₂ | 10-30% by weight |
| NaOH | 0.1-0.5% by weight |
| ammonium polyacrylate | 20-40% by weight |
| remainder H₂O | |

Coating liquid 2

| | |
|---|---|
| carboxymethyl cellulose | 5-15% by weight |
| glycerine | 10-20% by weight |
| ammonium polyacrylate | 20-40% by weight |
| remainder H₂O | |

A preferred example of an aqueous liquid for coating the reverse side of the paper is as follows:

| | |
|---|---|
| ammonium polyacrylate | 10-20% by weight |
| remainder H₂O | |

A further aspect of the present invention is the use of an aqueous liquid comprising ammonium polyacrylate for producing transfer paper, in particular for ink-jet printing.

The aqueous liquid can be used for coating the front and/or reverse side of transfer paper, as described above.

Another further aspect of the invention is a transfer paper, in particular for ink-jet printing, which is coated, on the front side which is to be printed and optionally on the reverse side, with ammonium polyacrylate, in particular in the amounts given above, for example in an amount of 1-25 g per m² paper on the front side and for example 0.5-15 g per m² paper on the reverse side.

The coating, in particular the coating of the front side, may in addition comprise further additives as stated above.

Another further aspect of the invention is a method for printing transfer paper, in which a layer of sublimable pigments is applied to the front side of a transfer paper as described above, for example by ink-jet printing. The pigments can be applied in conventional printing inks by known methods using conventional devices, for example ink-jet printers. After the application, the printed transfer paper is dried at room temperature or at a raised temperature of up to 80° C. Surprisingly, it has been found that the pigments do not exhibit any tendency towards smearing during application and drying.

The printed transfer paper can be used in a known manner for printing articles, in particular textiles.

Thus, another further aspect of the present invention is a printed transfer paper for printing articles, in particular textiles, which is coated on the front side with sublimable pigments and ammonium polyacrylate.

The textiles to be printed are conventionally undyed or white. However, pre-dyed textiles may optionally also be used. The textiles which are conventionally involved comprise a proportion of at least 50-60% by weight polyester and/or polyamide fibres or are coated with polyester and/or polyamide.

Surprisingly, with the transfer paper according to the invention, even stretchable textiles can be coated without smearing. For this purpose it is beneficial to use a first coating liquid which comprises a polyhydric alcohol, such as glycerine, and/or a cellulose derivative, such as carboxymethyl cellulose, as well as the ammonium polyacrylate. When heated, the paper which is coated with a liquid of this type adheres to the material to be printed, and so colour can be transferred from the paper to the material to be printed by conventional rotary printing methods without the pigments smearing.

Thus, another further subject-matter of the invention is a method for printing articles, in particular textiles, characterised in that the article to be printed is brought into contact with a printed transfer paper as described above at a raised temperature, for example 160-240° C., in such a way that sublimable pigments are transferred from the transfer paper to the article to be printed.

1. Method for producing transfer papers, in particular for ink-jet printing, comprising the steps of:
(a) applying a first aqueous liquid to the front side, which is to be printed, of a paper, the first aqueous liquid comprising ammonium polyacrylate, and subsequent drying, and
(b) optionally applying a second aqueous liquid to the reverse side of the paper and subsequent drying, the second liquid optionally comprising ammonium polyacrylate.

2. Method according to claim 1, characterised in that the first aqueous liquid comprises ammonium polyacrylate in a proportion of 10-50% by weight, in particular in a proportion of 20-40% by weight, based on the total weight of the liquid.

3. Method according to either claim 1, characterised in that the first and optionally the second aqueous liquid are applied to the paper in an amount of 10-40 g, in particular of 15-25 g per m².

4. Method according to claim 1, characterised in that ammonium polyacrylate is applied to the front side of the paper in an amount of 1-25 g, in particular 2-20 g dry weight.

5. Method according to claim 1, characterised in that the first and optionally the second aqueous liquid have a pH of ≧7, in particular 9.

6. Method according to claim 1, characterised in that the first liquid comprises further additives, in particular selected from:
(i) SiO₂ or silicates, for example in proportions of 10-50% by weight, in particular of 10-30% by weight
(ii) cellulose derivatives such as carboxymethyl cellulose, for example in proportions of 5-25% by weight, in particular of 5-15% by weight, and/or
(iii) polyhydric alcohols such as glycerine, for example in proportions of 5-25% by weight, in particular of 10-20% by weight,
the proportions by weight being based on the total weight of the first liquid in each case.

7. Use of an aqueous liquid comprising ammonium polyacrylate for producing transfer paper, in particular for ink-jet printing.

8. Transfer paper, in particular for ink-jet printing, characterised in that it is coated, on the front side which is to be printed and optionally on the reverse side, with ammonium polyacrylate, in particular in an amount of 1-25 g per m² paper on the front side and optionally 0.5-15 g per m² paper on the reverse side.

9. Method for printing transfer paper, characterised in that a layer of sublimable pigments is applied to the front side of a transfer paper according to claim 8, for example by ink-jet printing.

10. Printed transfer paper for printing articles, in particular textiles, characterised in that it is coated on the front side with sublimable pigments and ammonium polyacrylate.

11. Method for printing articles, in particular textiles, characterised in that the article to be printed is brought into contact with a printed transfer paper according to claim 10 at a raised temperature, in such a way that sublimable pigments are transferred from the transfer paper to the article to be printed.

12. Method according to claim 11, characterised in that the pigments are transferred from the paper to the article to be printed by rotary printing.
